(19) United States
(12) Patent Application Publication
(10) Pub. No.: US 2024/0078986 A1
(43) Pub. Date: Mar. 7, 2024

(54) Cushioned DrumSticks and Method of Play Therewith

(71) Applicant: Michael Lenz, Pueblo West, CO (US)

(72) Inventor: Michael Lenz, Pueblo West, CO (US)

(21) Appl. No.: 17/902,498

(22) Filed: Sep. 2, 2022

(51) Int. Cl. G10D 13/12

(52) U.S. Cl. CPC G10D 13/12

(57) ABSTRACT

A relatively short cushioned drumstick and a method of play are described that enable a percussionist to comfortably hold the drumstick in his/her hand while playing a drum with their hand while also permitting him/her to strike the drum or an accessory percussion idiophone instrument with the stick without having to pick up the stick or put it down thereafter.

### BACKGROUND

Typical drums are designed to be struck with drumsticks, hands, or both. These two methods of play create distinctly different tones and sound. Some drums can be played by either method or a combination of the two. For a percussionist to play a combination of the two, they will typically pick up one or more drumsticks with his/her hands, strike the drum with the drumsticks, and place the drumsticks aside to subsequently commence hand play. Switching back and forth can occur numerous times during a performance of a particular piece of music making the maintenance of the desired tempo or musical pace potentially difficult. Typical drumstick and mallet grip styles ergonomically restrict the percussionist from striking the drum by hand while holding the drumstick in that same hand. The percussionist can move the position of a drumstick in his/her hand that would permit hand play; however, the act of striking the drum with the hand and in particular the rapid deceleration of the hand and associated stick is typically uncomfortable and risks injury to the hand.

In other circumstances, a percussionist may be playing a hand drum but need to periodically strike an accessory percussion instrument, such as blocks, bells, guiros, and other idiophones, to accompany and accentuate the rhythmic patterns and sounds of the hand play. As such, percussionist playing on a hand drum will need to pick up one or two drumsticks in one or both of their hands to strike the accessory percussion instrument. For the percussionist to pick up a striking stick from and return it to its resting position often makes maintaining the desired tempo or musical pace of the musical composition far more difficult if not impossible thereby limiting the percussionist's capabilities.

### BRIEF DESCRIPTION OF THE DRAWINGS

FIG. 1 is an perspective view of cushioned drumstick compared to a prior art drumstick according to one embodiment of the present invention.

FIG. 2 is an exploded view of the cushioned drumstick according to one embodiment of the present invention.

FIG. 3 is a cross section of the cushioned drumstick of FIG. 1 taken along line 3-3.

FIG. 4 is an illustration showing an inside hand view on how to hold the stick in a hand in relation to a drum according to the embodiment of the present invention.

FIG. 5 is an illustration showing an outside hand view on how to hold the stick in a hand in relation to a drum and accessory rim mounted ideophone according to the embodiment of the present invention.

### DETAILED DESCRIPTION

Embodiments of the present invention comprise a cushioned drumstick and a method of play that enables a percussionist to comfortably hold the drumstick in his/her hand while playing a hand drum permitting him/her to strike the drum or an accessory percussion idiophone instrument with the stick without having to pick up the stick or put it down thereafter. Further, the design of the drumstick and the positioning of the stick in the player's hands permits simultaneous or near simultaneous striking of the drum with the hand and the stick, or near simultaneous striking of the drum with the hand and the idiophone with the stick. The result is an increase in the versatility of play available to a percussionist playing a hand drum.

At least one embodiment of the drum stick comprises a wood (or other suitable material such as a rigid or semi flexible polymer) solid or tubular rod substantially shorter in length and smaller in diameter than a typical drumstick. One or both ends of the stick can be rounded or shaped as desired to facilitate contact with one or both of an accessory instrument or a drumhead.

A cushioned tubular sleeve, typically comprised of an elastomeric foam, is received over the rod that covers a substantial portion of the rod and more particularly covers the portion held in the drummer's hand during play. The distal end of the stick may have more rod exposed (or uncovered) while the proximal end of the stick may have less rod or even no rod exposed. Advantageously, by flipping the drumstick in one's hand during play, the foam covered proximal end can be used to strike either the drumhead or an accessory instrument to create a muted sound.

For use in conjunction with hand play, embodiments of the drumsticks are gripped differently than is conventional for prior art traditional drumsticks. The drumstick with its cushioned sleeve is ergonomically designed for placement in the hand with the hand tuned down in its natural position with the proximal end of the cushioned sleeve portion of the drumstick placed on top of the thumb with the cushioned section extending under the index finger and then between the index and middle fingers. This effectively leaves the thumb, middle, ring, and baby fingers positioned below the cushioned section of the drumstick and free to strike a drumhead during play. The distal uncushioned end of the drumstick including the tip extends outwardly of the end of the fingers. The hand while holding the stick can then be placed into position to strike the drumhead with various sections of the hand and fingers, to strike the drumhead with the tip of the drumstick, and to strike the drumhead with both the hand and drumstick contemporaneously.

During play, the cushioned sleeve acts to protect the thumb and fingers from discomfort and/or injury caused by the repeated rapid decelerations of the hand and stick whenever a strike on the drumhead is made with either the hand, the stick, or both simultaneously. It is appreciated that the small diameter of the rod reduces the effective weight of the stick thereby reducing the force applied by the stick against the thumb and index finger during the rapid deceleration consequential to a strike. Further, the reduced length of the stick allows easier manipulation in raising or lowering the stick through hand manipulation as desired during play. The shorter length also facilitates keeping the tip positioned directly above the drumhead during play as opposed to extending beyond its circumferential edge.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

The term “drumstick” as used herein refers to a relatively thin elongated stick or member including associated elements, such as a sleeve, that is used to play a percussion instrument. As used herein and as appropriate in context, drumsticks include brushes, rods and mallets.

The term “rod” as used herein refers to an elongated member that is often, although not necessarily, round in cross section that has a cross-sectional width or diameter that is relatively small in relation to its length. A rod may have a solid cross section or the cross section may be tubular over all or part of its length.

### An Embodiment of a Cushioned Drumstick

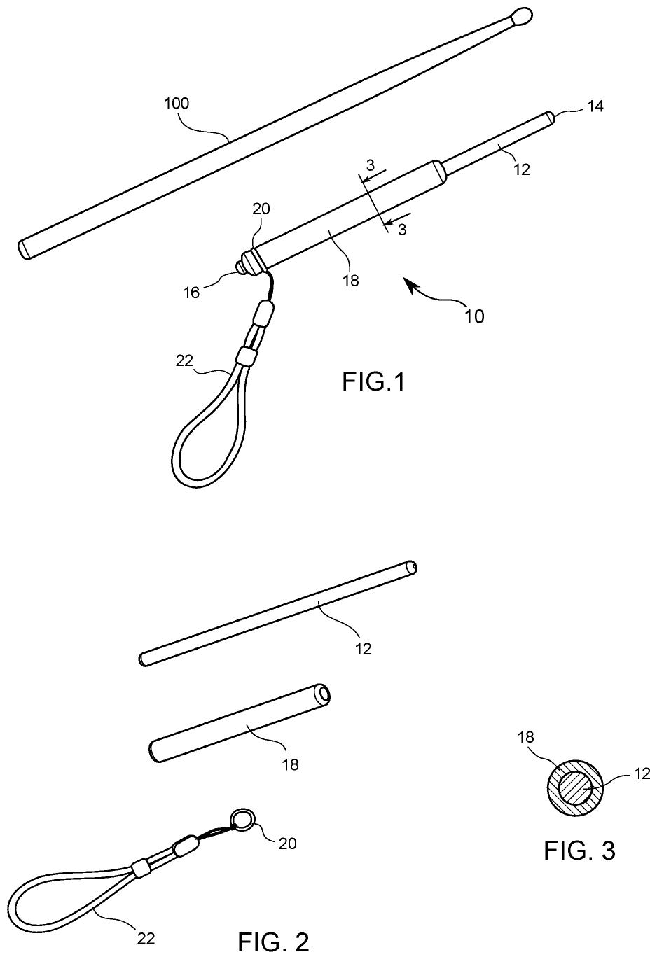

An embodiment of a cushioned drumstick 10 is illustrated in FIGS. 1-3 and typically comprises a rod 12 with distal and proximal rod ends 14 & 16 over which a cushioning sleeve 18 is received covering a portion of the rod's length. The rod (or rod) is often comprised of a suitable wood but can be made from other suitable natural and synthetic materials, such as, but not limited to, reinforced and unreinforced plastics and metal. The rod can be uniformly cylindrical, or tapered in sections. One or both rod ends can be shaped to form a semi-sphere, a ball, an oval, an acorn, or any other desired striking surface.

In one embodiment the diameter of the rod is typically ⅜″ at its maximum, which in a uniform cylindrical variations comprises most of its length. The length of the rod is usually 8-12″ long with 10″ being most typical although shorter and longer variations are known. In contrast most prior art drumsticks are over a half inch in maximum diameter and about 16″ in length. The smaller diameter and shorter length result in a rod that weighs about a third the weight of a typical prior art drum stick greatly reducing the resulting force from the rapid deceleration of the stick against the hand holding it when the drumhead is struck during hand play.

The cushioning sleeve 18 is typically comprised of a closed cell foam elastomer, such as neoprene or EPDM, although it can comprise other materials as well. For instance, variations comprising a soft latex, silicone, or rubber material are also known including materials often referred to as gel pad material. Most importantly, the sleeve provides a cushioning interface between the rod and the drummers fingers acting to dissipate and spread the force from the rapid deceleration of the hand and stick when the drum face is struck during hand play making the holding of the stick substantially more comfortable when compared to holding a prior art drumstick during hand play.

While the dimensions of the cushioned sleeve 18 can vary significantly depending on the dimensions of an associated rod 12 and the properties of the material of which the sleeve is comprised, the typical sleeve has an inside diameter of about 0.25″ to 0.31″ that stretches over a 0.375″ diameter rod providing a snug friction fit. As necessary or desired, the sleeve may also be adhesively bonded to the rod. The length of the sleeve can vary with the dimensions of the rod but is typically about 4-8 inches in length leaving about 3.5″ of rod exposed at the distal end and about 0.25″ exposed at the proximal end. The wall thickness of the sleeve can vary also depending on the diameter of the rod and the properties of the sleeve material but in typical embodiments it is about 0.13 to 0.19″ thick.

In some variations of the cushioned drumstick 10, a wrist strap 22 maybe provided as shown. The wrist strap comprises a strap loop sized to be received over a wrist, a length of cord attached on one end to form the strap loop, and an attachment mechanism secured to an opposite end of the cord. As shown the attachment mechanism comprises a rubber O-ring 20 that is stretched and placed over the cushioned sleeve 18. When the O-ring is released it contracts compressing the cushioned sleeve and securing the wrist strap to the cushioned stick. As can be appreciated the configuration of the wrist strap and its attachment mechanism can vary significantly in other variations.

### Methods of Using Embodiments of the Cushioned Drumstick

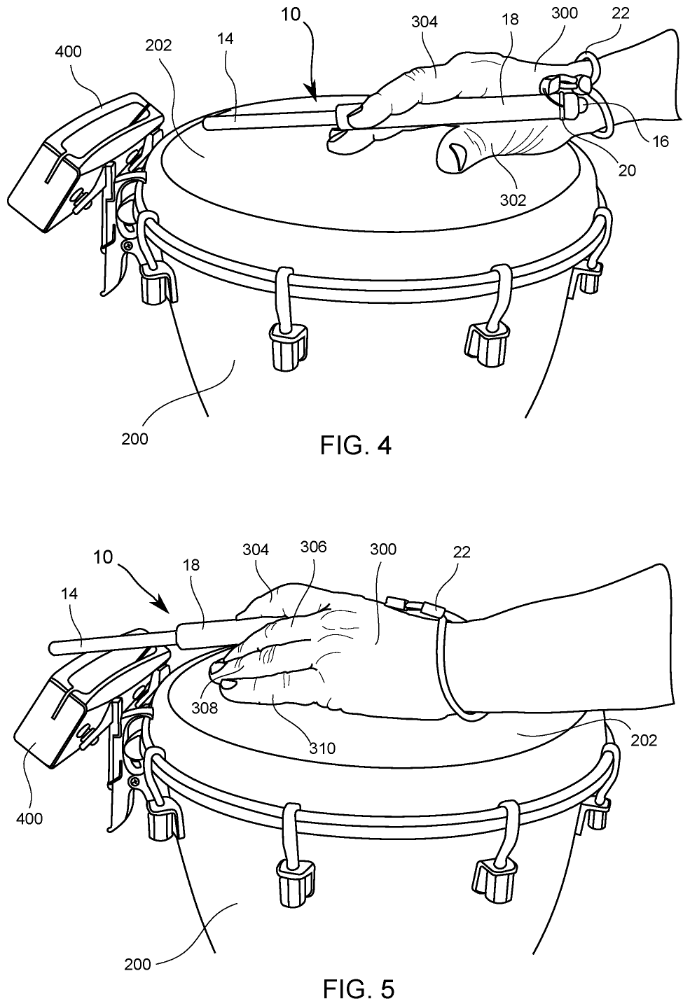

The length, weight, and importantly the cushioning permit embodiments of the stick 10, if held properly, to be retained in the hand 300 during hand play of a drum 200 with a substantially reduced risk of causing the drummer discomfort or injury. FIGS. 4 & 5 illustrate one manner of holding a cushioned drum stick.

The cushioned sleeve section of the stick 10 is placed on top of the top side of a drummer's thumb 302 typically resting against the base of the thumb and the adjacent side of the finger base frame proximate the thumb base. The stick extends forwardly between the index finger 304 and the middle finger 306 with the stick being held between facing surfaces of the respective fingers generally proximate their distal ends. The distal portion of the stick, especially the uncovered portion of the rod 12 including the distal tip 14, extends forwardly from the tips of the fingers. If the stick is equipped with a wrist strap 22, the strap is typically placed over the wrist prior to or contemporaneously with positioning the stick in the hand.

By manipulating the index and middle fingers 304 & 306 the distal tip 14 can be positioned vertically above, even with, or below the striking surfaces on the drummer's hand 300 permitting the drummer to control the stick's use during play. For instance, when the distal tip is positioned above the hand striking surfaces, it will not typically make contact with the drumhead 202 when the head is struck with the hand. When the distal tip is positioned even with the hand striking surfaces, the drumhead can be struck simultaneously with the hand and the tip creating a unique dual sound. Finally, when the distal tip is positioned below the hand striking surfaces, it will either hit the drumhead first and be followed with the hand strike or, as may be desired, only the tip will make contact with the head on a particular strike. Of course, the position of the hand and the position of the stick 10 can be varied in other ways both prior to a strike and while a strike is occurring to create other desirable strike combinations and the foregoing are merely examples.

In some situations, an idiophone 400 or other accessory instrument may be attached to the rim of the drum 200 as shown in FIGS. 4 & 5. The distal tip 14 of the stick in the drummer's hand 300 can be positioned as shown specifically in FIG. 5 to strike it as desired during play whether the idiophone is to be struck alone on a particular strike, or with, before, or after a corresponding hand strike on the drumhead.

In another variation of play, the drumstick 10 can be flipped over in the drummer's hand 300 such that the proximal tip 16 of the stick is extending forwardly from the fingertips. The drumhead 202 can be struck with the cushioned portion surrounding the tip 16 with or without the short portion of the exposed rod making contact as well. Additionally, when long periods of stick play are required in a musical piece, one or more cushioned sticks can be held and played in a manner substantially similar to that of prior art sticks. Numerous other combinations and variations of play are contemplated as would be obvious to someone of ordinary skill in the art given the knowledge of this disclosure.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A drumstick comprising:
a rod with distal and proximal tips having a length of about 10″ and a maximum rod diameter no greater than approximately 0.375″; and
a cushioning sleeve having a sleeve inside diameter of no greater than the maximum rod diameter, and a wall thickness of about 0.13-0.19″, the sleeve having a length of about 4-8″ being received over the rod to create a sleeved portion wherein the distal tip and a distal exposed portion of the rod extending rearwardly from the sleeve and are not covered by the sleeve.

2. The drumstick of claim 1, wherein the distal exposed portion is about 3.5″ in length.

3. The drumstick of claim 1, wherein the rod diameter is substantially uniform along the length of the rod.

4. The drumstick of claim 2, wherein the proximal tip and a proximal exposed portion about 0.25″ in length is not covered by the sleeve.

5. The drumstick of claim 1, wherein the sleeve comprises neoprene foam.

6. The drumstick of claim 1, wherein the sleeve comprises EPDM.

7. The drumstick of claim 1, wherein the sleeve is adhesively bonded to the rod.

8. The drumstick of claim 1, wherein the rod comprises wood.

9. The drumstick of claim 1, wherein the rod comprises a polymeric material.

10. The drumstick of claim 1 wherein one or both of the proximal and distal tips each have a shape of a semi-sphere, a ball, an oval, or an acorn.

11. The drumstick of claim 1 further including a wrist strap.

12. The drumstick of claim 11 wherein the wrist strap is secured to a remainder of the drumstick by way of an O-ring received over the cushioned sleeve.

13. A method of playing a drum with a drumhead using one or more drumsticks, the method comprising:
providing the one or more drumsticks, each drumstick of the one or more drumsticks comprising a rod with distal and proximal tips having a length of about 10″, and a cushioning sleeve, the sleeve having a length of about 4-8″ being received over the rod to create a sleeved portion wherein the distal tip and a distal exposed portion of the rod extending rearwardly from the sleeve and are not covered by the sleeve;
holding the drumstick in a hand wherein (i) the sleeved portion rests on top of the thumb when a palm of the hand faces downwardly, (ii) the sleeved portion extends under an index finger of the hand and between sides of the index finger and a middle finger, (iii) the distal exposed portion extends forwardly from the index and middle fingers; and
playing the drum by striking the drumhead with the hand while holding the drumstick.

14. The method of claim 13, further comprising:
playing the drum by striking the drumhead with the distal tip of the drumstick.

15. The method of claim 13, further comprising:
playing the drum by striking the drumhead with the distal tip of the drumstick contemporaneously with said striking the drumhead with the hand.

16. The method of claim 13, further comprising:
providing an accessory instrument attached to the drum; and
playing the accessory instrument by striking it with the drumstick.

17. The method of claim 13 further comprising:
playing the drum by striking the drumhead with the distal tip of the drumstick;
playing the drum by striking the drumhead with the distal tip of the drumstick contemporaneously with said striking the drumhead with the hand; and
playing the accessory instrument by striking it with the drumstick.

18. A drumstick comprising:
a wooden rod with distal and proximal tips having a length of 8-10″ and a maximum rod diameter no greater than 0.38″, the proximal and distal tips each having a shape of a semi-sphere, a ball, an oval, or an acorn; and
a foam sleeve having a sleeve inside diameter of no greater than the maximum rod diameter, and a wall thickness of about 0.13-0.19″, the sleeve having a length of about 4-6″ being received over the rod to create a sleeved portion wherein the distal tip and a distal portion of the rod extend about 3.5″ rearwardly from a distal end of the foam sleeve and are not covered by the sleeve; and
a wrist strap, the wrist strap being secured to one of the rod and the foam sleeve generally proximate the proximal tip.

19. The drumstick of claim 18, wherein the proximal tip and a proximal portion of the rod extend about 0.25″ from a proximal end of the sleeve and are not covered by the sleeve.

20. The drumstick of claim 19, wherein the wrist strap is coupled to the foam sleeve by a O-ring that received around the foam sleeve.
